(19) United States
(12) Patent Application Publication
(10) Pub. No.: US 2026/0229477 A1
(43) Pub. Date: Aug. 6, 2026

(54) MASS SPECTROSCOPE AND METHOD FOR ASSEMBLING PRE-RODS AND MAIN RODS OF MASS SPECTROSCOPE

(71) Applicant: HITACHI HIGH-TECH CORPORATION, Tokyo (JP)

(72) Inventors: Tsukasa SHISHIKA, Tokyo (JP); Shinji YOSHIOKA, Tokyo (JP); Koji ISHIGURO, Tokyo (JP)

(21) Appl. No.: 19/147,842

(22) PCT Filed: Dec. 11, 2023
(86) PCT No.: PCT/JP2023/044273

§ 371 Date: Jul. 14, 2025

(30) Foreign Application Priority Data
Feb. 1, 2023 (JP) 2023-014236

(51) Int. Cl. H01J 49/06; H01J 49/42

(52) U.S. Cl. CPC H01J 49/068; H01J 49/4215

(57) ABSTRACT

A mass spectroscope is capable of suppressing decreases in spectral sensitivity and resolution due to deformation during assembly of a multipole electrode. The mass spectroscope includes a multipole rod electrode having a plurality of rod pairs that are composed of pre-rods and main rods that are connected in the direction of an ion optical axis via an insulation member. In the multipole rod electrode, the pre-rods constitute pre-rod electrode portions, and the main rods constitute main rod electrode portions. The diameter of an inscribed circle on which the pre-rod electrode portions surround the ion optical axis is equal to the diameter of the inscribed circle on which the main rod electrode portions surround the ion optical axis, and the diameter of all of the pre-rods of the multipole rod electrode is greater than the diameter of the main rods connected to the pre-rods.

### TECHNICAL FIELD

This invention relates to a mass spectroscope and a method for assembling pre-rods and main rods of the mass spectroscope.

### BACKGROUND ART

In many cases, a mass spectroscope performs MS/MS analysis having a procedure in which from among ions generated by an ion source, the ions having a particular mass are selected, the ions are decomposed, and the masses of the decomposed ions are analyzed, thereby identifying the detailed structure of a sample.

For example, in the case of the mass spectroscope in which all of an ion transportation portion (Q0), a first ion separation portion (Q1), an ion dissociation portion (Q2), and a second ion separation portion (Q3) are configured of a multipole rod electrode (representatively, a quadrupole rod electrode), a high frequency (RF) voltage is applied to the multipole rod electrode of the Q0, so that the ions generated by the ion source are efficiently transmitted through the Q0 to be introduced into the Q1.

By applying the RF voltage and a direct current (DC) voltage to the multipole rod electrode, the Q1 can transmit, from among the introduced ions, only the ions having the particular mass, and is thus called a quadrupole mass filter (QMF). The particular ions selected and separated by the Q1 are introduced into the Q2.

The Q2 has the function of causing the ions to collide with the neutral gas (nitrogen, helium, argon, and the like) in the Q2 atmosphere to subject the ions to decomposition (CID) while transmitting the ions by applying the RF voltage to the multipole rod electrode. Thus, it is thus called a collision cell. The ions decomposed by the Q2 are introduced into the Q3.

By applying the RF voltage and the DC voltage to the multipole rod electrode like the Q1, the Q3 can transmit the introduced ions while separating the ions according to the mass, and the Q3 is thus also called the QMF. The ions separated by the Q3 are discharged from the outlet according to the mass, and are detected by a detector.

As such the multipole rod electrode, techniques described in Patent Literature 1 and Patent Literature 2 are known.

In Patent Literature 1, four main rod electrodes (31a to 31d) contained in a main electrode portion (31) are disposed in a rotationally symmetric manner around an ion optical axis (C). Meanwhile, among four pre-rod electrodes (32a to 32d) contained in a pre-electrode portion disposed in front of the main electrode portion (31), two are disposed to be in contact with a circle of radius r0, and the other two are disposed to be in contact with a circle of radius R0 that is larger than r0, yielding a rotational asymmetry around the ion optical axis (C).

In this manner, the shape of the acceptance in an x-y plane, which is related to the position of ions in the pre-electrode portion (32) becomes elliptical. This allows the shape of the acceptance to become gradually flat as the ions progress along the ion optical axis (C), reducing the discrepancy between the emittance of the incoming ions and the acceptance on the accepting side, and mitigating the loss of the ions during ion introduction.

As a result, in Patent Literature 1, description that the ion transmissivity of the entirety of the quadrupole mass filter can be improved is disclosed.

In addition, Patent Literature 2 discloses a method and an apparatus for reducing the ion reflection between multipole segments in a mass spectroscope by matching the effective potentials between the two segments.

The mass spectroscope has at least two multipole segments separated from each other along the longitudinal direction axis of the mass spectroscope such that a boundary region in which ions are drawn from the upstream segment into the downstream segment is present, the respective multipole segments being disposed around the longitudinal direction axis, and further includes rod shaped electrode pairs with a spacing having a field radius defined by an inscribed circle between the innermost portions of the respective electrodes.

The effective potential matching can be achieved by the supplying of RF signals having different amplitudes to the respective segments, and/or by correcting the intensity of the field of the segment. Further, in an embodiment, description that the multipole segment is configured such that the upstream multipole segment has a field radius smaller than the downstream segment is described.

### CITATION LIST

### Patent Literature

Patent Literature 1: WO2017/094146

Patent Literature 2: Japanese Unexamined Patent Application Publication (Translation of PCT Application) No. 2022-513801

### SUMMARY OF INVENTION

### Technical Problem

In the mass spectroscope, when the electrode configuring the multipole such as the quadrupole is assembled, the main rod and the pre-rod are required to be straightly disposed.

At this time, the main rod and the pre-rod are desirably coupled, but when a screw is used in the fixing portion of the coupling portion, deformation may be caused due to the torque of the screw.

That is, when the coupling portion is fixed by using the screw, the pre-rod whose axial direction length is short is displaced in the arranging position due to the torque caused when the screw is turned, so that the straightness with the main rod may not be held.

When the straightness of the main rod and the pre-rod is deteriorated, decreases in the sensitivity and the resolution of the detected spectrum can be caused.

An object of the present invention is to provide a mass spectroscope and a method for assembling pre-rods and main rods of the mass spectroscope capable of suppressing decreases in the sensitivity and the resolution of a spectrum due to deformation during the assembling of a multipole electrode.

### Solution to Problem

To achieve the above object, the present invention is configured as follows.

A mass spectroscope includes a multipole rod electrode having a plurality of rod pairs, the rod pairs includes pre-rods and main rods that are connected in the direction of an ion optical axis via an insulation member, in the multipole rod electrode, the pre-rods configures pre-rod electrode portions, and the main rods configures main rod electrode portions. In the mass spectroscope, the diameter of an inscribed circle on which the pre-rod electrode portions surround the ion optical axis is equal to the diameter of the inscribed circle on which the main rod electrode portions surround the ion optical axis, and the diameter of each of all the pre-rods configuring the multipole rod electrode is larger than the diameter of each of the main rods connected to the pre-rods via the insulation member.

A method for assembling pre-rods and main rods of a mass spectroscope includes: making an end surface of each pre-rod and an end surface of each main rod to be opposite to each other via an insulation member, and temporarily fixing the main rod, the insulation member, and the pre-rod by an insulation screw; inserting the pre-rod, the insulation member, and the main rod into an assembling guide jig of a cylindrical shape, and aligning in position such that a lower side surface of the pre-rod and a lower side surface of the main rod are aligned with a reference line; mounting a pre-rod position adjusting member onto the pre-rod via a pre-rod side surface position adjusting hole formed in the assembling guide jig, and mounting a main rod position adjusting member to the main rod via a main rod side surface position adjusting hole formed in the assembling guide jig, to align the positions of the pre-rod and the main rod; fixing the pre-rod and the main rod; removing the pre-rod position adjusting member and the assembling position adjusting jig; and removing the assembling guide jig from the pre-rod and the main rod.

### Advantageous Effects of Invention

According to the present invention, it is possible to provide a mass spectroscope and a method for assembling pre-rods and main rods of the mass spectroscope capable of suppressing decreases in the sensitivity and the resolution of a spectrum due to deformation during the assembling of a multipole electrode.

Objects, configurations, and effects other than the above will be apparent from the description of the following embodiments.

### BRIEF DESCRIPTION OF DRAWINGS

FIG. 1 is a perspective view of a multipole rod electrode according to an embodiment.

FIG. 2 is a front view of the multipole rod electrode according to the embodiment.

FIG. 3 is a diagram illustrating a method for manufacturing the rod electrode according to the embodiment.

FIG. 4 is a diagram illustrating spectral deterioration due to deformation at the time of coupling the rods.

FIG. 5 is a more detailed explanatory view of the method for manufacturing the rod electrode according to the embodiment.

FIG. 6 is a diagram illustrating a spectrum after the embodiment is applied.

FIG. 7 is a diagram illustrating the configuration of a mass spectroscope 28 at the time of causing an ion transmission portion 37 to function as an ion transportation portion Q0.

### DESCRIPTION OF EMBODIMENTS

Embodiments of the invention will now be described with reference to the drawings.

### Embodiment

### Ion Transmission Portion

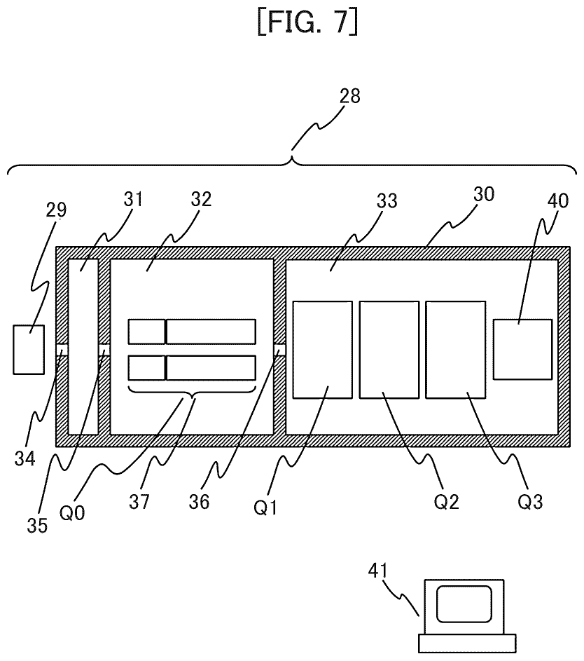

The present invention will be described by taking, as an example, a configuration in which a multipole rod electrode 1 configuring an ion transmission portion 37 (illustrated in FIG. 7) is a quadrupole rod electrode including four rod pairs of pre-rods and main rods.

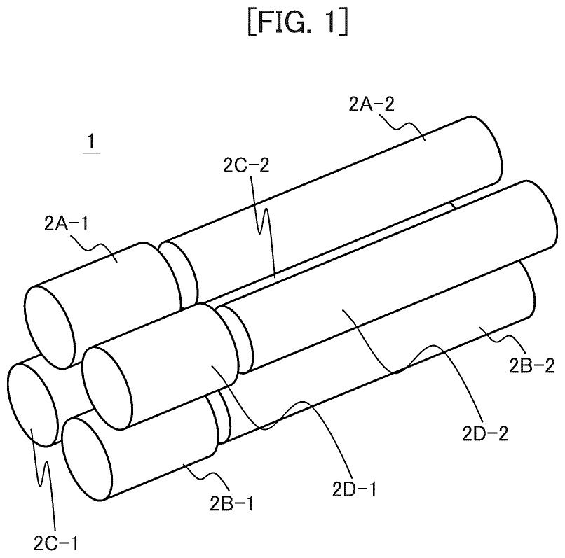

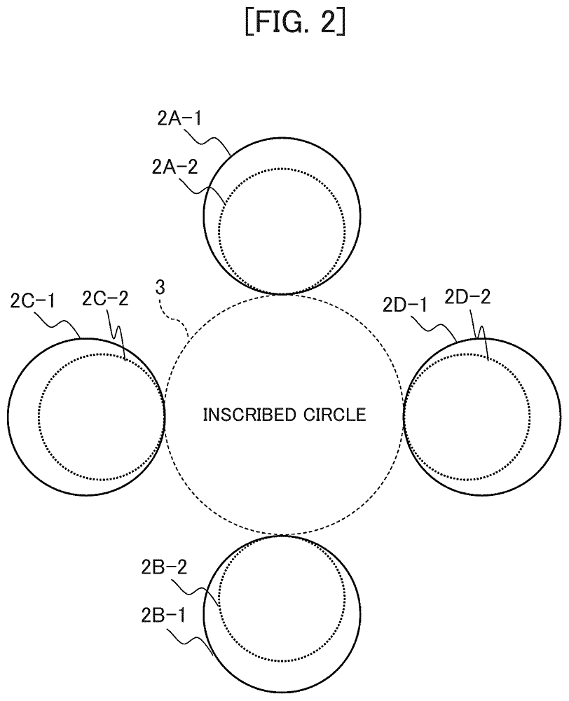

FIGS. 1 and 2 each illustrate an explanatory view of the configuration of the quadrupole rod electrode using an embodiment of the present invention. FIG. 1 is a perspective view of the multipole rod electrode 1, and FIG. 2 is a front view of the multipole rod electrode 1.

In FIGS. 1 and 2, the multipole rod electrode 1 includes four rod electrodes 2A to 2D. The four rod electrodes 2A to 2D are respectively divided into segment rods 2A-1, 2A-2, 2B-1, 2B-2, 2C-1, 2C-2, 2D-1, 2D-2.

Among these, the segment rods 2A-1, 2B-1, 2C-1, 2D-1 disposed on the upstream side in the direction of an ion optical axis are called the pre-rod, and the segment rods 2A-2, 2B-2, 2C-2, 2D-2 disposed on the downstream side in the direction of the ion optical axis are also called the main rod.

The pre-rod 2A-1 and the main rod 2A-2 are connected to each other in the direction of the ion optical axis. Likewise, the pre-rod 2B-1 and the main rod 2B-2, the pre-rod 2C-1 and the main rod 2C-2, and the pre-rod 2D-1 and the main rod 2D-2 are also connected to each other in the direction of the ion optical axis.

When the multipole rod electrode 1 is used as the ion transmission portion 37, ions are introduced from the single end (the pre-rods 2A-1 to 2D-1 side) of the multipole rod electrode 1 to be transmitted through the multipole rod electrode 1, and the ions are discharged from the opposite side (the main rods 2A-2 to 2D-2 side).

Next, a method for applying each voltage to the multipole rod electrode 1 by a power supply and a circuit will be described below.

High frequency voltages in reverse phases are applied to the rod electrodes 2A, 2B and the rod electrodes 2C, 2D, and further, respective different direct current voltages V1, V2 are applied to pre-rod electrode portions including the pre-rods 2A-1 to 2D-1, and main rod electrode portions including the main rods 2A-2 to 2D-2.

The respective pre-rods 2A-1 to 2D-1 and the respective main rods 2A-2 to 2D-2 are disposed around the ion optical axis, and are disposed with a spacing having a field radius defined by an inscribed circle 3 between the innermost portions of the respective rods.

The ion transmission portion 37 includes a power supply circuit (not illustrated) which supplies power to the multipole rod electrode 1 such that the effective potential of the pre-rod electrode portion exceeds the effective potential of the main rod electrode portion, or is substantially equal to the effective potential of the main rod electrode portion, so as to reduce the reflection of the ions transmitted through the boundary region.

In many cases, since the length of the pre-rods 2A-1 to 2D-1 (the length in the direction of the ion optical axis) is made to be 10 to 20% relative to the length of the main rods 2A-2 to 2D-2 (the length in the direction of the ion optical axis), long electrodes are used for the main rods 2A-2 to 2D-2.

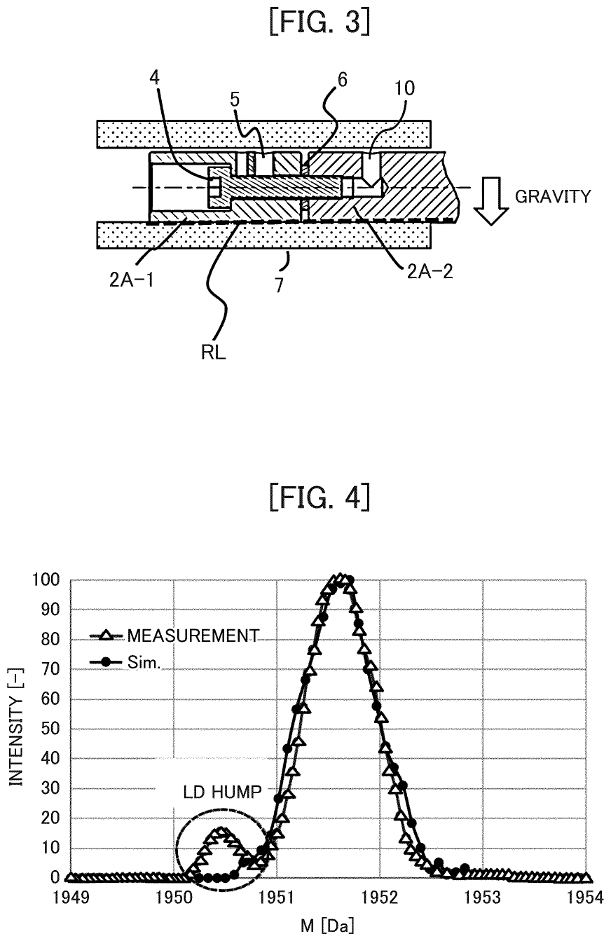

As illustrated in FIG. 3, the main rod 2A-2 is provided with a screw hole 10 for fixing the electrode and supplying the voltage on the opposite side of the surface that generates a quadrupole electric field (the surface on the inscribed circle 3 side of FIG. 2). Also in the rod electrode that is subjected to the precise processing including these processes, it is difficult to cause deformation near the processing to be 2 μm or less with respect to the diameter.

On the other hand, when the radius of the inscribed circle from the main rod inlet portions that fasten the pre-rods 2A-1 to 2D-1 and the main rods 2A-2 to 2D-2 by insulation screws 4, to the main rod outlet portions that become the end surfaces of the main rods 2A-2 to 2D-2 becomes small, decreases in the amount of the ions transmitted and the resolution are caused.

In this way, when the screw inserted into a screw hole 5 is used for the fixing portion of the coupling portion, deformation is caused due to the torque of the screw. This deformation leads to decreases in the sensitivity and the resolution of the detected spectrum.

FIG. 4 is a diagram illustrating spectral deterioration due to deformation at the time of coupling the pre-rods 2A-1 to 2D-1 and the main rods 2A-2 to 2D-2. In FIG. 4, the line connected by a plurality of black circles denotes a waveform by simulation, and the line connected by a plurality of triangles is a measured waveform.

In the portion of the measured waveform denoted as the LD hump, a hump shaped waveform (peak) that should not be intrinsically caused is caused.

In this embodiment, by taking the processing deformation in the rod in manufacture into consideration, as illustrated in FIGS. 1 and 2, the radius of each of the pre-rods 2A-1 to 2D-1 is increased with respect to the radius of each of the main rods 2A-2 to 2D-2.

Here, the multipole rod electrode 1 is configured such that the diameter of the inscribed circle 3 on which the pre-rods 2A-1 to 2D-1 surround the ion optical axis is equal to the diameter of the inscribed circle 3 on which the main rods 2A-2 to 2D-2 surround the ion optical axis, and the diameter of each of all the pre-rods 2A-1 to 2D-1 configuring the multipole electrode is larger than the diameter of each of the main rods 2A-2 to 2D-2 connected to the pre-rods 2A-1 to 2D-1 via an insulation member (insulation washer) 6.

Specifically, for example, as illustrated in FIG. 3, in an assembling guide jig 7, the respective rod opposite surfaces (the surfaces on the inscribed circle 3 side of FIG. 2) of the pre-rod 2A-1 and the main rod 2A-2 are opposite to each other. Then, the lower side surface of the pre-rod 2A-1 and the lower side surface of the main rod 2A-2 are aligned in the assembling guide jig 7 by using gravity so as to be aligned with a reference line RL.

With this, the tilting of the pre-rod 2A-1 and the step amount between the pre-rod 2A-1 and the main rod 2A-2 can be minimized.

Like the pre-rod 2A-1 and the main rod 2A-2, the pre-rod 2B-1 and the main rod 2B-2, the pre-rod 2C-1 and the main rod 2C-2, and the pre-rod 2D-1 and the main rod 2D-2 are also aligned in the assembling guide jig 7 by using gravity.

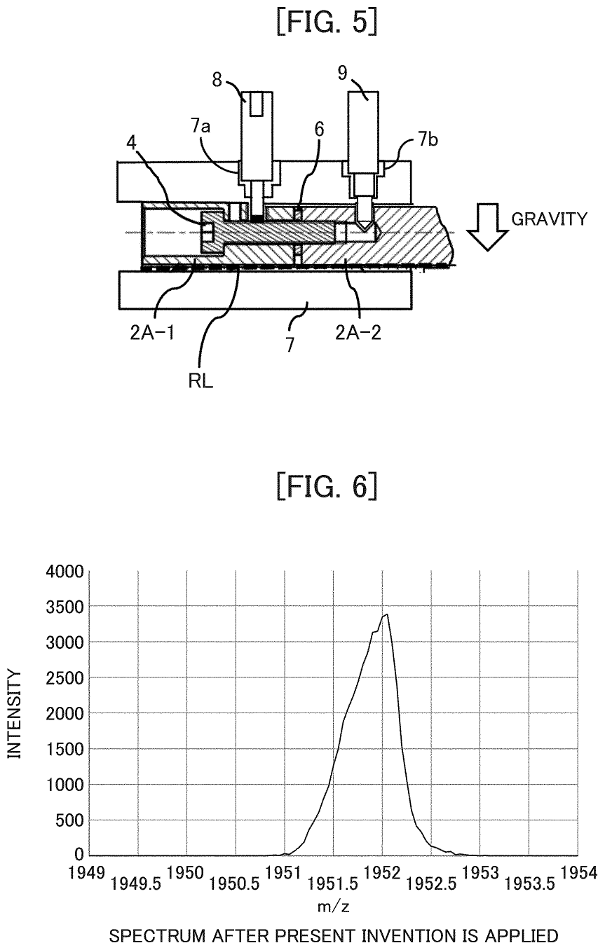

FIG. 5 is a diagram for explaining, in more detail, a method for assembling the pre-rod 2A-1 and the main rod 2A-2.

In FIG. 5, the end surface of the main rod 2A-2 and the end surface of the pre-rod 2A-1 are opposite to each other via the insulation member 6, and the pre-rod 2A-1 and the insulation member 6 are temporarily fixed to the main rod 2A-2 by lightly tightening the insulation screw 4.

Then, the pre-rod 2A-1 and the main rod 2A-2 are inserted into the assembling guide jig 7 of a cylindrical shape, and the positions of the pre-rod 2A-1 and the main rod 2A-2 are aligned.

That is, the lower side surface of the pre-rod 2A-1 and the lower side surface of the main rod 2A-2 are aligned in the assembling guide jig 7 by using gravity so as to be aligned with the reference line RL. With this, the pre-rod 2A-1 and the main rod 2A-2 can be disposed in the position relationship as illustrated in FIG. 2.

Next, a resin strut (pre-rod position adjusting member) 8 is mounted into the screw hole 5 on the pre-rod 2A-1 side via a pre-rod side surface position adjusting hole 7a formed in the assembling guide jig 7, an assembling position adjusting jig (main rod position adjusting member) 9 is mounted into the screw hole 10 on the main rod 2A-2 side via a main rod side surface position adjusting hole 7b formed in the assembling guide jig 7, and the tapped hole positions of the pre-rod 2A-1 and the main rod 2A-2 are aligned.

Then, the screw is tightened via the resin strut 8 at a constant tightening torque with a torque driver, and the insulation screw 4 is tightened for fixing.

Next, the resin strut 8 and the assembling position adjusting jig 9 are removed from the pre-rod 2A-1 and the main rod 2A-2, and the assembling guide jig 7 is removed from the pre-rod 2A-1 and the main rod 2A-2.

In the case of the quadrupole rod electrode, the respective geometrical shapes of the pre-rod electrode portions and the main rod electrode portions are featured by a rate of R/r₀. R denotes a rod radius, and r₀ denotes the radius of the inscribed circle which is in contact with the ends of the electrodes. In this embodiment, a diameter 2R of the pre-rod electrode portions is set to be at least 0.03% larger than the diameter 2R of the main rod electrode portions.

FIG. 6 illustrates actual measurement data for the case where the diameter of the main rods 2A-2 to 2D-2 is 9.498 mm with respect to the diameter of 9.5 mm of the pre-rods 2A-1 to 2D-1, and the diameter of the pre-rods 2A-1 to 2D-1 is increased by 0.03%.

In the data illustrated in FIG. 6, it is found that the hump shaped peak present in FIG. 4 is eliminated. The diameter of the pre-rods 2A-1 to 2D-1 is preferably larger, by 0.03% or more and 0.08% or less, than the diameter of the main rods 2A-2 to 2D-2.

The multipole rod electrode 1 described above has the configuration illustrated in FIG. 2, and the processing deformation is suppressed, so that the straightness of the main rods 2A-2 to 2D-2 and the pre-rods 2A-1 and 2D-1 is secured, and decreases in the sensitivity and the resolution of the detected spectrum can be suppressed.

In this embodiment, the quadrupole rod electrode has been exemplified as an example, but the technical idea of the present invention is not limited to the quadrupole rod electrode, and is also applicable to various multipole rod electrodes having the pre-rod electrode portions and the main rod electrode portions, such as a hexapole rod electrode and an octupole rod electrode.

### Mass Spectroscope

Hereinbelow, a mass spectroscope having a configuration in which the ion transmission portion using the multipole rod electrode 1 as described above is caused to function as an ion transportation portion (Q0) will be described.
FIG. 7 illustrates the configuration of a mass spectroscope 28 for the case where the ion transmission portion 37 according to this embodiment is caused to function as the ion transportation portion Q0.

In FIG. 7, the mass spectroscope 28 mainly includes an ion source 29 and a vacuum chamber 30. For the ion source 29, an ion source using APCI, ESI, and other various ionizing methods can be used.

The vacuum chamber 30 is divided into a first vacuum chamber 31, a second vacuum chamber 32, and a third vacuum chamber 33, which are respectively independently evacuated by a vacuum pump (not illustrated), and are held in pressure regions of several hundred Pa or less, several Pa or less, and 0.1 Pa or less, respectively.

The ions generated in the ion source 29 are passed through a first fine hole 34, and are introduced into the first vacuum chamber 31. Thereafter, the ions are passed through a second fine hole 35, and are introduced into the second vacuum chamber 32. Thereafter, the ions are passed through the ion transportation portion Q0. For the ion transportation portion Q0, the multipole rod electrode 1 as described above can be used, and the voltage applying method and the like are also basically the same, but as compared with the case of using as an ion dissociation portion Q2, the voltage conditions of the high frequency voltage and the direct current voltage are typically different.

In addition, the inlet electrode, the outlet electrode, a piping 8, a case, and the like used in the ion dissociation portion Q2 are not necessarily provided.

The ions that are passed through the ion transportation portion Q0 are passed through a third fine hole 36, and are introduced into the third vacuum chamber 33. Thereafter, the ions are passed through a first ion separation portion Q1. For the first ion separation portion Q1, the QMF and the like configured of four rod electrodes are used, and from among the ions introduced into the first ion separation portion Q1, only the ions having a particular m/z are separated and are passed.

The ions having the particular m/z that are passed through the first ion separation portion Q1 are introduced into the ion dissociation portion 02. The ions that are passed through the ion dissociation portion Q2 are introduced into a second ion separation portion Q3. For the second ion separation portion Q3, the QMF and the like including four rod electrodes are used, and the ions introduced into the second ion separation portion Q3 are separated according to the m/z, and are passed.

The ions that are passed through the second ion separation portion Q3 are detected by a detector 40. In addition, the mass spectroscope 28 includes a control portion 41 for receiving the instruction input from the user, and receiving the control of the voltage and the like.

According to the present invention, it is possible to provide the mass spectroscope and the method for assembling the pre-rod 2A-1 and the main rod 2A-2 of the mass spectroscope capable of securing the straightness of the main rods 2A-2 to 2D-2 and the pre-rods 2A-1 to 2D-1, and suppressing decreases in the sensitivity and the resolution of the spectrum due to deformation during the assembling of the multipole electrode.

It should be noted that the above-described example has been described by the example in which the ion transmission portion 37 is used as the ion transportation portion Q0, but the ion transmission portion 37 according to the present invention is also applicable to the first ion separation portion Q1, the ion dissociation portion Q2, and the second ion separation portion Q3.

In addition, the present invention is applicable as long as the mass spectroscope includes a plurality of rod pairs of the pre-rods and the main rods.

The present invention is not limited to the above-described embodiments, and further includes various modifications. For example, the above-described embodiments have been described in detail in order to facilitate the understanding of the present invention, and the present invention is not necessarily limited to those including all of the described configurations.

### LIST OF REFERENCE SIGNS

q1: multipole rod electrode, 2A, 2B, 2C, 2D: rod electrode, 2A-1, 2B-1, 2C-1, 2D-1: pre-rod, 2A-2, 2B-2, 2C-2, 2D-2: main rod, 3: inscribed circle, 4: insulation screw, 5: screw hole, 6: insulation member (insulation washer), 7: assembling guide jig, 7a: pre-rod side surface position adjusting hole, 7b: main rod side surface position adjusting hole, 8: resin strut (pre-rod position adjusting member), 9: assembling position adjusting jig (main rod position adjusting member), 10: screw hole, 28: mass spectroscope, 30: vacuum chamber, 31: first vacuum chamber, 32: second vacuum chamber, 33: third vacuum chamber, 34: first fine hole, 35: second fine hole, 36: third fine hole, 37: ion transmission portion, 40: detector, 41: control portion, Q0: ion transportation portion, Q1: first ion separation portion, Q2: ion dissociation portion, Q3: second ion separation portion, RL: reference line

1. A mass spectroscope comprising a multipole rod electrode having a plurality of rod pairs, the rod pairs including pre-rods and main rods that are connected in the direction of an ion optical axis via an insulation member, in the multipole rod electrode, the pre-rods configuring pre-rod electrode portions, the main rods configuring main rod electrode portions,
wherein a diameter of an inscribed circle on which the pre-rod electrode portions surround the ion optical axis is equal to a diameter of the inscribed circle on which the main rod electrode portions surround the ion optical axis, and
wherein a diameter of each of all the pre-rods configuring the multipole rod electrode is larger than a diameter of each of the main rods connected to the pre-rods via the insulation member.

2. The mass spectroscope according to claim 1,
wherein the difference between the diameter of each of the pre-rods and the diameter of each of the main rods is 0.03% or more and 0.08% or less of the diameter of each of the main rods.

3. A method for assembling pre-rods and main rods of a mass spectroscope, comprising:
making an end surface of each pre-rod and an end surface of each main rod to be opposite to each other via an insulation member, and temporarily fixing the main rod, the insulation member, and the pre-rod by an insulation screw;
inserting the pre-rod, the insulation member, and the main rod into an assembling guide jig of a cylindrical shape, and aligning in position such that a lower side surface of the pre-rod and a lower side surface of the main rod are aligned with a reference line;
mounting a pre-rod position adjusting member onto the pre-rod via a pre-rod side surface position adjusting hole formed in the assembling guide jig, and mounting a main rod position adjusting member to the main rod via a main rod side surface position adjusting hole formed in the assembling guide jig, to align the positions of the pre-rod and the main rod;
fixing the pre-rod and the main rod;
removing the pre-rod position adjusting member and the main rod position adjusting member; and
removing the assembling guide jig from the pre-rod and the main rod.

4. The method according to claim 3,
wherein the difference between a diameter of each of the pre-rods and a diameter of each of the main rods is 0.03% or more and 0.08% or less of the diameter of each of the main rods.
